(19) United States
(12) Patent Application Publication
(10) Pub. No.: US 2020/0198595 A1
(43) Pub. Date: Jun. 25, 2020

(54) Reusable logistics box for pedal battery car

(71) Applicant: Weilong Wang, Weihai City (CN)

(72) Inventor: Weilong Wang, Weihai City (CN)

(21) Appl. No.: 16/809,594

(22) Filed: Mar. 5, 2020

(30) Foreign Application Priority Data
Dec. 2, 2019 (CN) 2019112156992

(51) Int. Cl. B60S 5/06

(52) U.S. Cl. CPC B60S 5/06

(57) ABSTRACT

The invention discloses a reusable logistics box for a pedal-type battery car, which comprises a bottom plate and a fixing block fixedly arranged on the right end of the front end of the bottom plate. The bottom plate and the fixing block are provided with automatic opening and closing. Device, the automatic opening and closing device includes a first side plate symmetrically disposed on the bottom plate and the upper and lower sides of the fixing block, and a first sponge pad is fixed on an end surface of the opposite side of the first side plate, and The rear side of the fixing block is provided with a front wheel fixing device, and the first side plate is provided with a pressing rod device. The present invention can be automatically opened or closed, which avoids the laborious and tedious steps of disassembling the logistics box after the arrival of the goods, which makes the access more convenient Quick and fast, saving a lot of time and cost, improving work efficiency before and after transportation, and the front wheel fixing device and lever device make it unnecessary to use iron wires when fixing the battery car, and can effectively reduce the skew of the battery car during transportation To reduce the possibility of scratching.

### CROSS-REFERENCES TO RELATED APPLICATIONS

The present application claims priority from Chinese application No. 2019112156992 filed on Sep. 19, 2019 which is hereby incorporated by reference in its entirety.

### TECHNICAL FIELD

The present invention relates to the technical field of battery car peripheral equipment, and in particular to a reusable logistics box for pedal-type battery car consignment.

### BACKGROUND OF THE INVENTION

The battery car is a pure electric motor vehicle powered by a battery (battery). It is not only low-priced, but also economical and environmentally friendly. The battery cart is basically a disposable wooden shipping rack. The battery cart is fixed in the rack with iron wires. Although it can reduce the vibration during transportation, the fixing and disassembly before and after transportation is too laborious and cumbersome. It is likely to cause scratch damage to the battery car. The present invention illustrates a device capable of solving the above problems.

### BRIEF SUMMARY OF THE INVENTION

### Technical Problem

The current battery car consignment basically uses a disposable wooden shipping rack. The battery car is fixed in the shipping rack with iron wires. Although the vibration during transportation can be reduced, the fixing and disassembly work before and after transportation is too laborious and tedious, and the transportation process Medium and large may cause scratch damage to the battery car.

In order to solve the above problem, this example designs a reusable logistics box used for pedal battery car consignment, and a reusable logistics box used for pedal battery car consignment in this example includes a bottom plate and a fixed A fixing block at the right end of the front end of the bottom plate, an automatic opening and closing device is provided on the bottom plate and the fixing block, and the automatic opening and closing device includes a first symmetrically disposed on the bottom plate and the upper and lower sides of the fixing block. A side plate, a first sponge pad is fixedly provided on the opposite end surface of the first side plate, and first and second ends of the fixing block are symmetrically provided with first turning grooves with opposite opening directions and openings to the right; A first turning block is rotatably provided between the front and rear walls, and one end of the first turning block is fixedly connected to the first side plate. When a discharge car needs to be taken into the logistics box, the first turning block can be controlled by transmission. One side plate is flipped up and down for easy access. The rear side of the fixing block is provided with a front wheel fixing device. The front wheel fixing device includes a symmetrically arranged up and down on the rear side of the left end surface of the fixing block and the opening is to the left. First A slider cavity, a first screw is rotatably provided between the upper and lower walls of the first slider cavity, and a first screw is slidably arranged in the first slider cavity to extend from the left end of the first screw to and A first slider extending from the left end to the outside, an end surface on the opposite side of the first slider is fixedly provided with a splint outside the first slider cavity, and a second sponge pad is fixed on the opposite end surface of the splint. The clamping plate is used for clamping the front wheel to prevent the handle and the front wheel from twisting and shaking during transportation. The first side plate is provided with a pressing rod device, and the pressing rod device includes a pressing rod device provided in the first side plate. A lifting chamber, a second motor is fixed in the rear wall of the lifting chamber, a sixth screw is connected to the front end of the second motor, and a screw connected to the sixth screw is slidable forward and backward in the lifting chamber. Lifting blocks.

Preferably, the automatic opening and closing device includes a second slider cavity symmetrically provided on the upper and lower end faces of the fixed block and on the left side of the first turning groove, and an inner wall of a side close to the second slider cavity may be A second screw is provided for rotation, and a second slider threadably connected to the second screw is provided in the second slider cavity to be able to slide up and down, and an opposite end of the second slider is provided with a connecting groove. A right side of the first side plate is provided in a third slider cavity, and a third slider is slidably arranged in the third slider cavity. The inner wall of a side close to the third slider cavity is connected to the third slider cavity. There is a connection channel opposite to the opening. The connection channel is slidably provided with an abutment rod whose one end is fixedly connected to the third slider, and the other end of the abutment rod is rotatably connected to the front and rear of the connection groove. Between the walls.

Preferably, a first linkage cavity is provided in the fixed block and between the second slider cavity, and upper and lower ends of the first linkage cavity are rotatably provided to extend to the first linkage cavity. A first rotation shaft fixedly connected to the second screw rod in two slider cavities, and a first gear is fixedly installed in the first linkage cavity, and the bottom plate is behind the fixing block. A power cavity is provided, and a first motor is fixed on the right wall of the power cavity. A second rotating shaft is dynamically connected to the left end of the first motor. A first helical gear is fixed on the second rotating shaft. A third rotating shaft with a front end extending into the first linkage cavity is rotatably provided in the wall, and a second oblique meshing with the first helical gear is fixedly provided in the power cavity at the rear end of the third rotating shaft. For the gear, a third screw engaged with the first rotating shaft is fixed at the front end of the third rotating shaft in the first linkage cavity.

Preferably, the left end surface of the bottom plate is provided with a second turning groove opening forward and leftward, and a fourth rotating shaft is rotatably provided between the upper and lower walls of the second turning groove, and the fourth rotating shaft is fixed on the fourth rotating shaft. A second side plate with a front end extending to the outside is provided. A rack slot hole is provided at the rear end of the second side plate and to the left of the power cavity. The fourth rotation shaft is fixed in the rack slot hole. An arc-shaped rack is provided, and the left end of the second rotating shaft extends into the second turning groove, and a fourth screw meshing with the arc-shaped rack is fixedly provided.

Preferably, the front wheel fixing device includes a second linkage cavity provided in the fixing block and between the first slider cavity, and the second linkage cavity is rotatably provided between front and rear walls. A fifth rotation shaft that extends into the first slider cavity and is fixedly connected to the first screw, and the fifth rotation shaft is fixed with a second gear in the second linkage cavity. The second helical gear is fixed in the second linkage cavity with a fifth screw meshing with the second gear.

Preferably, the pressing rod device includes a pressing rod slideway provided on the lifting block and penetrating vertically. The first sponge pad is provided with a lifting channel which communicates with the lifting cavity and is opposite to the opening. A push rod that passes through the lifting channel is slidably provided in the push rod slideway. The lower wall of the lifting cavity on the lower side communicates with a push rod outlet that opens downward. When the lifting block slides forward, When the front limit position is reached, the slide rail of the pressure lever is in communication with the outlet of the pressure lever and the pressure lever can slide down through the outlet of the pressure lever.

Preferably, a clamping groove is communicated with the rear wall of the pressure rod slideway on the lower side, a clamping cavity is provided at the lower end of the rear end surface of the pressing rod, and the rear end of the clamping cavity is slidably provided with an extendable rear end. To the card block in the card slot, a spring is fixedly connected to the front end of the card block and the inner wall of the card block cavity, a pull wire is fixed at the front end of the card block, and one end of the pull wire extends through the lower end of the pressure rod A pull ring is fixed externally.

The beneficial effect of the present invention is that the present invention can be automatically opened or closed, avoiding the laborious and tedious steps of disassembling the logistics box upon arrival, making picking and placing faster and faster, saving a lot of time and cost, and improving the work of picking and placing before and after transportation. Efficiency, and the front wheel fixing device and the pressing rod device eliminate the need to use iron wires when fixing the battery car, and can effectively reduce the skew of the battery car during transportation and reduce the possibility of scratch damage.

### BRIEF DESCRIPTION OF THE DRAWINGS

For ease of explanation, the present invention is described in detail by the following specific embodiments and the accompanying drawings.

FIG. 1 is a schematic diagram of the overall structure of a reusable logistics box for a pedal battery car according to the present invention; FIG.

FIG. 2 is a cross-sectional view taken along the “A-A” direction of FIG. 1;

FIG. 3 is a cross-sectional view taken along the “B-B” direction of FIG. 1;

FIG. 4 is a cross-sectional view taken along the “C-C” direction of FIG. 1;

FIG. 5 is a cross-sectional view taken along the “D-D” direction in FIG. 2.

### DETAILED DESCRIPTION OF THE INVENTION

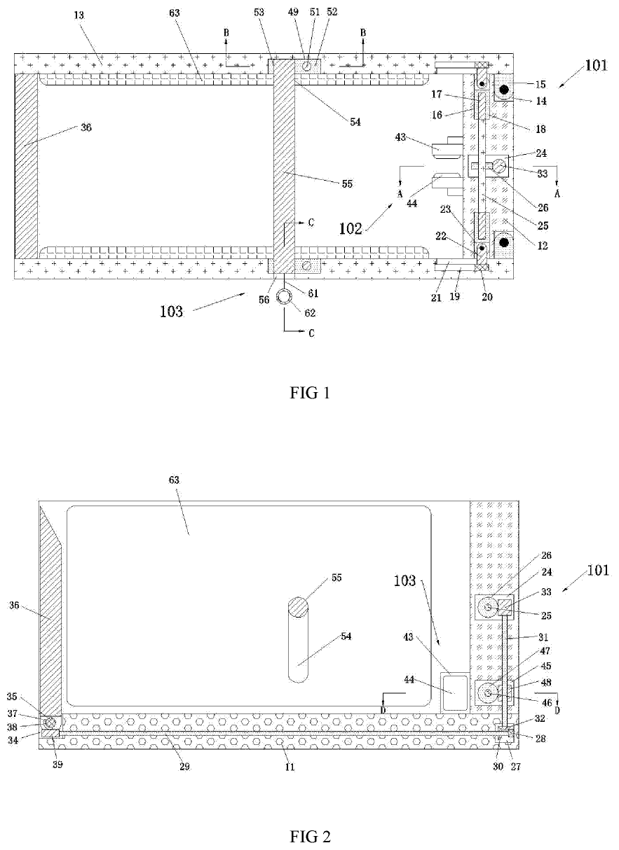

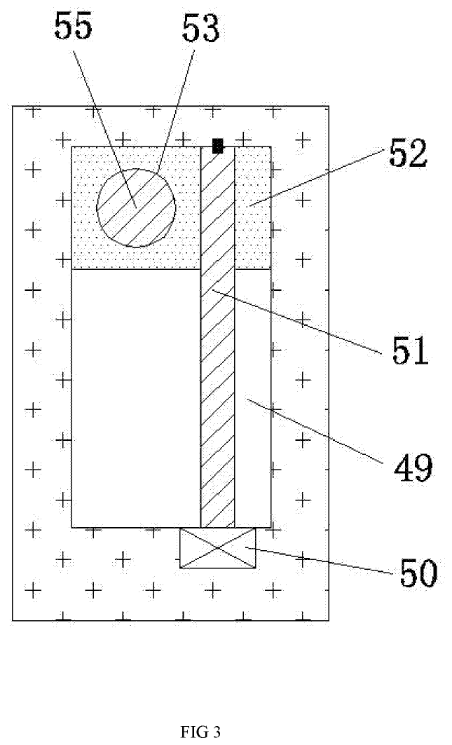

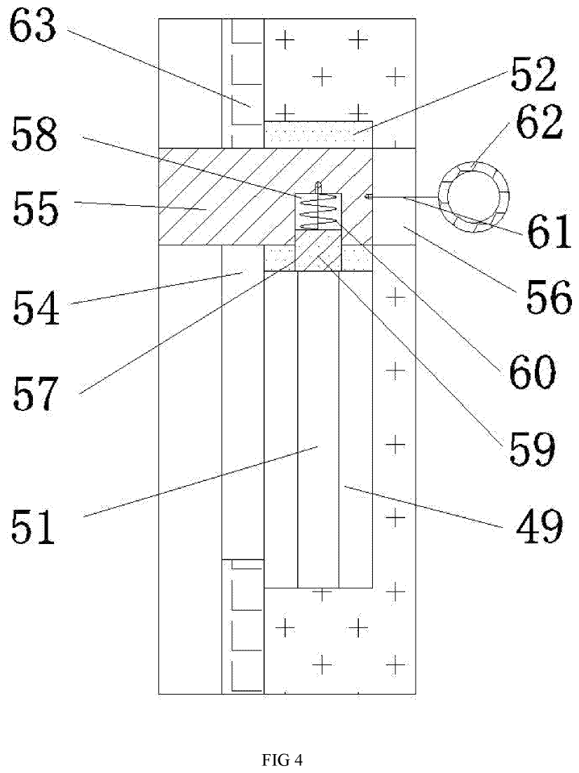

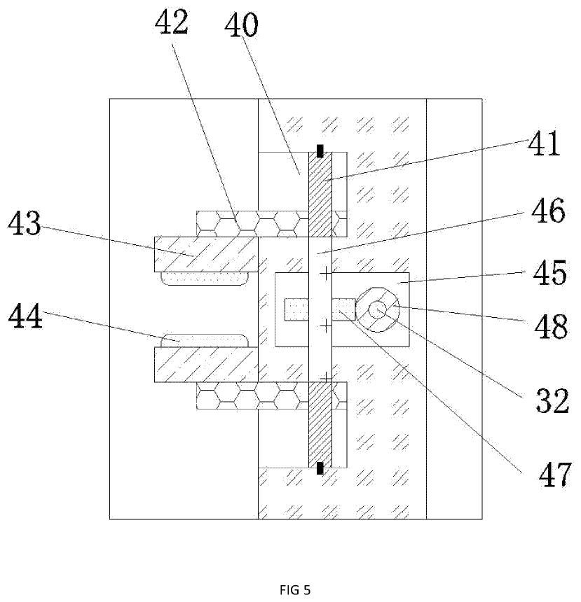

The present invention is described in detail below with reference to FIGS. 1-5. For convenience of description, the orientation described below is defined as follows: the up-down, left-right, front-back direction described below is consistent with the up-down, left-right, front-back direction of the projection relationship of FIG. 1 itself.

The present invention relates to a reusable logistics box for pedal-type battery carts, which is mainly applied to the logistics-consignment of pedal-type battery carts. The present invention will be further described below with reference to the accompanying drawings of the present invention:

A reusable logistics box for a pedal-type battery car according to the present invention includes a bottom plate 11 and a fixing block 12 fixedly disposed on the right end of the front end surface of the bottom plate 11, the bottom plate 11 and the fixing block 12 An automatic opening and closing device 101 is provided on the upper side. The automatic opening and closing device 101 includes first side plates 13 symmetrically disposed on the upper and lower sides of the bottom plate 11 and the fixing block 12. A first sponge pad 63 is fixed on the side end surface. The upper and lower end surfaces of the fixing block 12 are symmetrically provided with first turning grooves 14 with opposite opening directions and openings to the right. The first turning grooves 14 are rotatable between the front and rear walls. A first flip block 15 is provided. One end of the first flip block 15 is fixedly connected to the first side plate 13. When a discharge car needs to be taken into the logistics box, the first side plate 13 can be controlled by transmission. The upper and lower sides are flipped up for easy access. The rear side of the fixing block 12 is provided with a front wheel fixing device 102. The front wheel fixing device 102 includes an upper part and a lower part symmetrically provided on the rear side of the left end surface of the fixing block 12 and the opening is leftward. First slider cavity 40, the upper and lower walls of the first slider cavity 40 A first screw 41 is rotatably provided, and a first slider 42 threadably connected to the left end of the first screw 41 and extending outwardly is provided in the first slider cavity 40 to be slidable up and down, An end face on the opposite side of the first slider 42 is fixedly provided with a splint 43 outside the first slider cavity 40, and a second sponge pad 44 is fixed on the end surface on the opposite side of the cleat 43. The first side plate 13 is provided with a lever device 103 for clamping the front wheel to prevent twisting of the handle and the front wheel during transportation. The lever device 103 includes a lever device 103 provided in the first side plate 13. A lifting chamber 49 is provided with a second motor 50 fixed in a rear wall of the lifting chamber 49. A sixth screw 51 is dynamically connected to the front end of the second motor 50. A screw connection is provided in the lifting chamber 49 to be able to slide back and forth. The lifting block 52 of the sixth screw 51.

Beneficially, the automatic opening and closing device 101 is described in detail below. The automatic opening and closing device 101 includes a second slider cavity 16 symmetrically disposed on the upper and lower end surfaces of the fixing block 12 and on the left side of the first turning groove 14. A second screw 17 is rotatably provided on an inner wall of a side close to the second slider cavity 16, and a first screw threaded to the second screw 17 is slidably arranged in the second slider cavity 16. Two sliders 18, the opposite end of the second slider 18 is provided with a connecting groove 23, the right side of the first side plate 13 is provided in a third slider cavity 19, and the third slider cavity 19 may be A third slider 20 is slid left and right, and the inner wall of a side close to the third slider cavity 19 is provided with an open connection channel 21 opposite to each other. One end of the connection channel 21 that is slidable is fixedly connected to The abutting rod 22 of the third slider 20 is rotatably connected between the front and rear walls of the connecting groove 23 at the other end.

Beneficially, a first linkage cavity 24 is provided in the fixing block 12 and between the second slider cavity 16, and the first linkage cavity 24 is rotatably provided between the upper and lower walls and extends to the upper and lower ends to A first rotating shaft 25 is fixed in the second slider cavity 16 and is fixedly connected to the second screw 17. A first gear 26 is fixed in the first rotating shaft 25. A power chamber 27 is provided in the bottom plate 11 and behind the fixing block 12. A first motor 28 is fixed on the right wall of the power chamber 27. A second shaft 29 is dynamically connected to the left end of the first motor 28. A first helical gear 30 is fixed on the two rotation shafts 29, and a third rotation shaft 31 with a front end extending into the first linkage cavity 24 is rotatably provided in the front wall of the power chamber 27, and the third rotation shaft 31 is rearward. A second helical gear 32 meshing with the first helical gear 30 is fixedly disposed in the power cavity 27, and a front end of the third rotating shaft 31 is fixedly meshed with the first linkage cavity 24. The third screw 33 of the first rotating shaft 25.

Beneficially, the left end surface of the bottom plate 11 is provided with a second turning groove 34 which is opened forward and leftward, and a fourth rotation shaft 35 is rotatably provided between the upper and lower walls of the second turning groove 34. A second side plate 36 with a front end extending outward is fixed on the rotating shaft 35. A rack slot hole 37 is provided on the left side of the second side plate 36 on the left side of the power chamber 27. An arc-shaped rack 38 is fixedly disposed in the rack slot hole 37, and the left end of the second rotating shaft 29 extends into the second overturning slot 34 and a first-piece meshing with the arc-shaped rack 38 is fixedly provided. Four screw 39.

Beneficially, the front wheel fixing device 102 is described in detail below. The front wheel fixing device 102 includes a second linkage cavity 45 provided in the fixing block 12 and between the first slider cavity 40. A fifth rotation shaft 46 is rotatably provided between the front and rear walls of the second linkage cavity 45 and extends to the first slider cavity 40 and is fixedly connected to the first screw 41. A second gear 47 is fixedly disposed in the second linkage cavity 45, and a fifth screw 48 meshing with the second gear 47 is fixedly disposed in the second helical gear 32.

Beneficially, the plunger device 103 is described in detail below. The plunger device 103 includes a plunger slideway 53 provided on the lifting block 52 penetrating up and down. The first sponge pad 63 is provided with the The lifting cavity 49 communicates with the opposite opening lifting channel 54. A pressing rod 55 passing through the lifting channel 54 is provided in the pressing rod slideway 53 on the upper and lower sides, and the lifting cavity 49 on the lower side is provided. The lower wall is provided with a pressure lever outlet 56 with an opening downward. When the lifting block 52 slides forward to the front limit position, the pressure lever slideway 53 and the pressure lever outlet 56 communicate with each other and the pressure lever 55 It can slide down through the pressure bar outlet 56.

Beneficially, a clamping groove 57 is connected to the rear wall of the lower lever slideway 53 on the lower side, and a block cavity 58 is provided at the lower end of the rear end face of the pressure lever 55. The rear end can extend to a clamping block 59 in the card slot 57. A spring 60 is fixedly connected to the front end of the clamping block 59 and the inner wall of the clamping block cavity 58. A pull wire 61 is fixed to the front end of the clamping block 59. One end of the pull wire 61 extends through the lower end of the pressing rod 55 to the outside and a pull ring 62 is fixedly provided.

The following describes in detail the use steps of a reusable logistics box for pedal-type battery carts in this article in conjunction with FIGS. 1 to 5:

At the beginning, the first side plate 13 is in a horizontal state, the second slider 18 is in the extreme position near the first linkage cavity 24 side, the third slider 20 is in the right extreme position, and the front end of the second side plate 36 is in the front extreme position. The first slider 42 is at the extreme position close to the side of the second linkage cavity 45, the lifting block 52 is at the front extreme position, the upper and lower ends of the pressing rod 55 are in the pressing rod slideway 53, and the rear end of the clamping block 59 extends to the clamping groove. Within 57.

When the battery car needs to be parked on the bottom plate 11, the pull wire 61 is pulled down through the pull ring 62, and then the pull wire 61 pulls the clamping block 59 back into the block cavity 58. When the pull is continued, the pressing rod 55 is lowered and the pressing rod 55 is lowered. To the point where the battery car is parked, the first motor 28 starts to drive the second shaft 29 to rotate, and the fourth screw 39 rotates with the second shaft 29 and drives the arc-shaped rack 38 and the fourth shaft 35 to rotate, and then the second side The plate 36 is turned to the left until the upper end of the second side plate 36 touches the ground. When the second rotating shaft 29 rotates, the first helical gear 30 rotates with the second rotating shaft 29, and the third rotating shaft 31 rotates through the gear meshing, and then the first The three rotating shafts 31 drive the third screw 33 and the fifth screw 48 to rotate. When the third screw 33 rotates, the first gear 26 is rotated, and then the first rotating shaft 25 is rotated with the first gear 26 and the second screw 17 is rotated. The connection drives the second screw 17 to slide away from the first linkage cavity 24, and further drives the first side plate 13 to flip up and down by the abutment rod 22, so as to stop the battery car on the bottom plate 11, and the fifth screw 48 rotates Drive the second The wheel 47 rotates, and the fifth rotation shaft 46 rotates with the second gear 47 and drives the first screw 41 to rotate, and the first slider 42 is driven to slide away from the second linkage cavity 45 through the screw connection, so that the battery car is parked when parked. The front wheels are placed between the splints 43.

After the middle support frame for the battery car is parked, the first motor 28 reverses and drives the second side plate 36 to flip back to the original state, and simultaneously drives the upper and lower first side plates 13 to flip back to the initial state, and the first side plate 13 At the same time, the clamp plate 43 is driven to slide toward the side close to the second linkage cavity 45 while being flipped, and the clamp plate 43 clamps the front wheel of the battery car to prevent the handlebar and the front wheel from twisting during transportation. At this time, the lever 55 is pushed back. In the initial state, the lower end of the block 59 under the action of the spring 60 returns to the initial state. The second motor 50 is started to drive the sixth screw 51 to rotate, and the lifting block 52 is driven to the pressure bar by screwing 55 is offset with the pedal of the battery car to ensure that the battery car as a whole will not sway and cause scratches when the transportation vehicle is bumpy.

The beneficial effect of the present invention is that the present invention can be automatically opened or closed, avoiding the laborious and tedious steps of disassembling the logistics box upon arrival, making picking and placing faster and faster, saving a lot of time and cost, and improving the work of picking and placing before and after transportation. Efficiency, and the front wheel fixing device and the pressing rod device eliminate the need to use iron wires when fixing the battery car, and can effectively reduce the skew of the battery car during transportation and reduce the possibility of scratch damage.

In the above manner, those skilled in the art can make various changes according to the working mode within the scope of the present invention.

1. A reusable logistics box for a pedal-type battery car is characterized by comprising a bottom plate and a fixing block fixedly arranged on the right end of the front end surface of the bottom plate, and the bottom plate and the fixing block are provided with automatic opening and closing. Device, the automatic opening and closing device includes a first side plate symmetrically disposed on the bottom plate and the upper and lower sides of the fixing block, and a first sponge pad is fixed on an end surface of the opposite side of the first side plate, and The upper and lower end surfaces of the fixing block are symmetrically provided with first flip grooves with opposite opening directions and right openings. A first flip block is rotatably provided between the front and rear walls of the first flip groove, and one end of the first flip block is fixedly connected. On the first side plate, when it is necessary to take the electric discharge car into the logistics box, the first side plate can be controlled to be turned upside down and down to facilitate access by transmission, and a front wheel is provided on the rear side of the fixed block. A fixing device, the front wheel fixing device comprises a first slider cavity which is symmetrically arranged up and down on the rear side of the left end surface of the fixing block and opens to the left; A screw, said first slip A first slider that is threadedly connected to the left end of the first screw and extends to the left is provided in the cavity to be able to slide up and down, and the opposite end surface of the first slider is outside the cavity of the first slider. A splint is fixedly provided, and a second sponge pad is fixedly provided on the opposite end face of the splint. The splint is used to clamp the front wheel to prevent the handle and the front wheel from shaking during transportation. The first side plate is provided with A rod pressing device, which includes a lifting cavity provided in the first side plate, a second motor is fixed in the rear wall of the lifting cavity, and a sixth screw is connected to the front end of the second motor. A lifting block that is screwed to the sixth screw is provided in the lifting cavity to be able to slide back and forth.

2. The reusable logistics box for pedal-type battery carts according to claim 1, wherein the automatic opening and closing device comprises symmetrically disposed on the upper and lower end surfaces of the fixed block and turned over the first A second slider cavity on the left side of the groove, a second screw is rotatably provided on the inner wall of a side close to the second slider cavity, and a screw connection to the second slider cavity is provided. The second slider of the second screw, the opposite end of the second slider is provided with a connecting groove, the right side of the first side plate is provided in a third slider cavity, and the third slider cavity can be left and right. A third slider is provided for sliding, and the inner wall of a side close to the third slider cavity is provided with a connection passage opposite to the opening. The left and right sides of the connection passage are fixedly connected to the third slide. The abutting rod of the block, and the other end of the abutting rod is rotatably connected between the front and rear walls of the connecting groove.

3. The reusable logistics box for pedal-type battery carts according to claim 1, wherein a first linkage cavity is provided in the fixed block and between the second slider cavity, A first rotation shaft is rotatably provided between the upper and lower walls of the first linkage cavity, and the upper and lower ends extend into the second slider cavity and are fixedly connected to the second screw. A first gear is fixed in the first linkage cavity, a power cavity is provided in the bottom plate and behind the fixing block, a first motor is fixed on the right wall of the power cavity, and the left end of the first motor is dynamically connected with A second rotating shaft, a first helical gear is fixed on the second rotating shaft, and a third rotating shaft with a front end extending into the first linkage cavity is rotatably provided in the front wall of the power cavity, and the third rotating shaft A second helical gear meshing with the first helical gear is fixedly arranged at the rear end in the power cavity, and a first meshing gear meshing with the first rotating shaft is fixedly arranged at the front end of the third rotating shaft in the first linkage cavity. Third screw.

4. The reusable logistics box for pedal-type battery cart consignment according to claim 1, characterized in that: the left end surface of the bottom plate is provided with a second flip slot opening forward and opening left, and the first A fourth rotation shaft is rotatably provided between the upper and lower walls of the two turning grooves, and a second side plate with a front end extending outward is fixed on the fourth rotation shaft, and the rear end of the second side plate is located to the left of the power chamber. A rack slot is provided on the side, an arc rack is fixed on the fourth rotating shaft in the rack slot, and the left end of the second rotating shaft extends into the second turning slot and fixedly engages. A fourth screw on the arc-shaped rack.

5. The reusable logistics box for a pedal-type battery car according to claim 1, wherein the front wheel fixing device comprises a fixing block provided in the fixing block and in the first slider cavity. A second linkage cavity therebetween, and a fifth rotation shaft between the front and rear walls of the second linkage cavity that is rotatably provided and extends into the first slider cavity and is fixedly connected to the first screw, The fifth rotating shaft is fixed with a second gear in the second linkage cavity, and the second helical gear is fixed with a fifth screw meshing with the second gear in the second linkage cavity.

6. The reusable logistics box for a pedal-type battery car according to claim 1, wherein the pressing rod device includes a pressing rod slideway provided on the lifting block and penetrating vertically, and The first sponge pad is provided with a lifting channel that communicates with the lifting cavity and is opposite to the opening. The pressure rod slideways on the upper and lower sides are provided with sliding rods that pass through the lifting channel. The lower wall of the lifting cavity is connected with a pressure bar outlet with an opening downward. When the lifting block slides forward to the front extreme position, the pressure bar slideway communicates with the pressure bar outlet and the pressure bar can pass through the bar. The outlet of the pressure lever slides out.

7. The reusable logistics box for pedal-type battery cart consignment according to claim 6, characterized in that the rear wall of the slide bar on the lower side is connected with a clamping slot, and the rear end face of the slide bar The lower end is provided with a block cavity, and a block with a rear end extending into the card slot is provided in the block cavity, and the front end of the block is fixedly connected with a spring in the block cavity. A pull wire is fixed at the front end of the clamping block, one end of the pull wire extends to the outside through the lower end of the pressing rod, and a pull ring is fixedly provided.
